(19) United States
(12) Patent Application Publication
(10) Pub. No.: US 2026/0166595 A1
(43) Pub. Date: Jun. 18, 2026

(54) CLEANING AGENT COMPOSITION AND PASTE CLEANING METHOD

(71) Applicant: NOF Corporation, Tokyo (JP)

(72) Inventors: Nanae HABARA, Hyogo (JP); Hiroki EZUKA, Hyogo (JP); Hiroya FUJITA, Hyogo (JP)

(73) Assignee: NOF Corporation, Tokyo (JP)

(21) Appl. No.: 19/119,834

(22) PCT Filed: Oct. 4, 2023
(86) PCT No.: PCT/JP2023/036213

§ 371 Date: Apr. 10, 2025

(30) Foreign Application Priority Data
Oct. 11, 2022 (JP) 2022-163189

(51) Int. Cl. B08B 3/12; A47L 13/17; C11D 1/29; C11D 1/72; C11D 1/94

(52) U.S. Cl. CPC B08B 3/12; A47L 13/17; C11D 1/29; C11D 1/72; C11D 1/94

(57) ABSTRACT

A cleaning agent which exhibits high cleaning power against a paste, inhibits an emulsion on a screen-printing plate, has a uniform appearance, and contains water, is provided. The contains: 0.5-10 mass % of component (A); 1-10 mass % of component (B); 1-10 mass % of component (C); 0.1-5 mass % of component (D); and 65.0-97.4 mass % of water. Component (A) has an alicyclic hydrocarbon group or an aromatic hydrocarbon group and has a molecular weight of 90-180. Component (B) is represented by formula (1). Component (C) is represented by formula (2). Component (D) is a surfactant having an aromatic group and the average number of moles of C₂H₄O is 20-100.

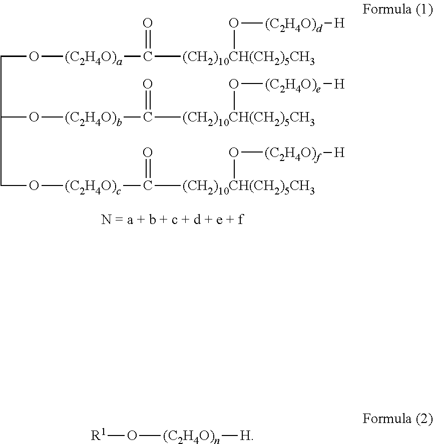

(R¹ is a C6-18 branched alkyl group, n is the average number of added moles of C₂H₄O groups and n is 2-12).

### TECHNICAL FIELD

The present invention relates to a cleaning agent composition and a method for cleaning a paste.

### BACKGROUND ART

In recent years, as electronic devices have become smaller and lighter, development of thinner and finer electronic circuits and electronic substrates has been progressing. Printed electronics has been put into practical use as a technology that meets the demands for the thinner and finer circuits and substrates. Screen printing is commonly used in such a technology, and electronic circuits are formed by printing a paste, which is a mixture of conductive particles and a resin, onto the surface of a substrate by using a screen plate.

Conventionally, fluorocarbon-based or chlorine-based organic solvents have been mainly used to clean devices obtained by using these pastes and screen plates using these pastes. However, from the viewpoint of protecting the natural environment and improving work environment, there is a growing demand for VOC reduction, and semi-aqueous and aqueous cleaning agents that use organic solvents of a hydrocarbon that is non-fluorocarbon or glycol-based organic solvents are preferred in recent years.

For example, Patent Literature (hereinafter, referred to as PTL) 1 describes a cleaning agent composition for a screen printing plate, containing a glycol ether-based organic solvent and water.

For example, PTL 2 describes a cleaning agent composition for metal nano-ink, containing hydrogen peroxide, an acid, water, and other organic solvents.

For example, PTL 3 describes a cleaning agent composition for a screen printing plate, containing an amine, a glycol ether-based organic solvent, and water.

### CITATION LIST

### Patent Literature

### PTL 1

Japanese Patent Application Laid-Open No. 2000-267293

### PTL 2

Japanese Patent Application Laid-Open No. 2017-165830

### PTL 3

Japanese Patent Application Laid-Open No. 2021-50254

### SUMMARY OF INVENTION

### Technical Problem

A cleaning agent for paste is used to remove a paste, but there is a concern that the emulsion used for pattern formation on a screen plate may elute or swelling may occur during the cleaning process. In particular, in the case of a semi-aqueous cleaning agent or an aqueous cleaning agent, the elution or swelling of an emulsion is more likely occur than an organic solvent. On the other hand, a high cleaning power is also required in order to correspond to increasingly fine circuit wiring. For example, the cleaning agent composition described in PTL 1 can suppress the elution and swelling of the emulsion, but PTL 1 only confirms the solubility of the ink with respect to the cleaning power, and there is a concern that the cleaning power from the fine circuit wiring may be insufficient. Further, the cleaning agent composition described in PTL 2 has a high cleaning power for copper nano ink, but there is a concern that the emulsion would elute because the cleaning agent composition contains a strong acid such as sulfuric acid or hydrochloric acid and hydrogen peroxide, which has an oxidizing action.

Further, from the viewpoint of ease of handling and storage stability, the cleaning agent is preferably a uniform solution. However, organic solvents with high hydrophobicity have a low solubility in water, leading to phase separation. In PTL 3, an aqueous cleaning agent is obtained from the cleaning agent composition by combining a hydrophilic glycol ether and a hydrophobic glycol ether, but PTL 3 describes that the aqueous cleaning agent is separated into two layers, raising concerns about poor storage stability.

As described above, there has been no cleaning agent for paste that achieves a uniform appearance and can achieve both cleaning power and suppression of the influence on an emulsion.

The present invention has been made in view of the above circumstances, and an object of the present invention is to provide a cleaning agent that has a high cleaning power for a paste adhered to a device or a screen plate, suppresses the influence on an emulsion of the screen plate, achieves a uniform appearance, and includes water as a main component.

### Solution to Problem

A cleaning agent composition according to one aspect of the present invention for achieving the above object relates to a cleaning agent composition containing 0.5% by mass or more and 10% by mass or less of a component (A), 1% by mass or more and 10% by mass or less of a component (B), 1% by mass or more and 10% by mass or less of a component (C), 0.1% by mass or more and 5% by mass or less of a component (D), and 65.0% by mass or more and 97.4% by mass or less of water.

The component (A) is a compound having an alicyclic hydrocarbon group or an aromatic hydrocarbon group and having a molecular weight of 90 or more and 180 or less,
the component (B) is a compound represented by Formula (1) below,
the component (C) is a compound represented by Formula (2) below, and
the component (D) is a surfactant having an aromatic group.

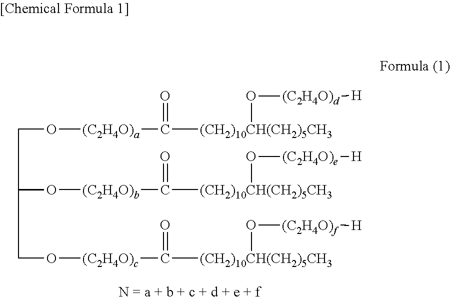

(In Formula (1), N representing the sum of average addition mole numbers of C₂H₄O group is a number of 20 or more and 100 or less).

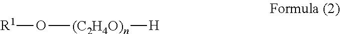

(In Formula (2), R¹ represents a branched alkyl group having 6 or more and 18 or less carbon atoms, and n representing an average addition mole number of C₂H₄O group is a number of 2 or more and 12 or less).

A method for cleaning a paste according to one aspect of the present invention for achieving the above object includes the following steps: preparing a screen plate with a surface to which the paste adheres; and bringing the cleaning agent composition into contact with the surface of the screen plate, the surface being a surface to which the paste adheres.

### Advantageous Effects of Invention

A cleaning agent for paste according to the present invention has a sufficient cleaning power to remove a paste, suppresses the influence on the emulsion of a screen plate, achieves a uniform appearance, and is a cleaning agent with water as the main component.

### DESCRIPTION OF EMBODIMENTS

Hereinafter, embodiments of the present invention will be described.

A cleaning agent composition (hereinafter, also simply referred to as “cleaning agent”) relating to an embodiment of the present invention contains 0.5% by mass or more and 10% by mass or less of a component (A) below, 1% by mass or more and 10% by mass or less of a component (B) below, 1% by mass or more and 10% by mass or less of a component (C) below, 0.1% by mass or more and 5% by mass or less of a component (D) below, and 65.0% by mass or more and 97.4% by mass or less of water.

The component (A) is a compound having an alicyclic hydrocarbon group or an aromatic hydrocarbon group and having a molecular weight of 90 or more and 180 or less,
the component (B) is a compound represented by Formula (1):

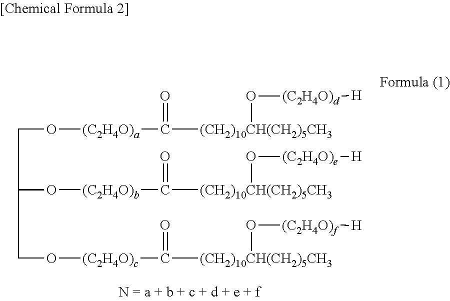

in Formula (1), N representing a sum of average addition mole numbers of C₂H₄O group is a number of 20 or more and 100 or less,
the component (C) is a compound represented by Formula (2):

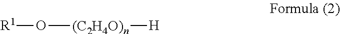

in Formula (2), R¹ represents a branched alkyl group having 6 or more and 18 or less carbon atoms, and n representing an average addition mole number of C₂H₄O group is a number of 2 or more and 12 or less, and
the component (D) is a surfactant having an aromatic group.

Hereinafter, each component included in the cleaning agent will be described.

### [Component (A)]

A component (A) is a compound having an alicyclic hydrocarbon group or a compound having an aromatic hydrocarbon group, and has a molecular weight of 90 or more and 180 or less. The cleaning agent may contain only one type of component (A) or may contain a plurality of types of component (A).

The component (A) has a high removability of the paste, and when combined with components (B) to (D), the compatibility with water, which is the main component of the cleaning agent, is sufficiently increased. For this reason, the component (A) enhances the removability of the paste while preventing the cleaning agent from becoming cloudy or undergoing phase separation, thereby enabling the cleaning agent to maintain a uniform appearance even after long-term storage (storage stability is improved).

The number of atoms constituting the alicyclic hydrocarbon group in the component (A) is not particularly limited, but the alicyclic hydrocarbon group preferably has a six-membered ring, and more preferably has a six-membered ring including six carbon atoms. Further, the number of atoms constituting the aromatic hydrocarbon group in the component (A) is not particularly limited, but the aromatic hydrocarbon group preferably has a six-membered ring, and more preferably has a six-membered ring including six carbon atoms.

The total number of carbon atoms in the component (A) is preferably 6 or more and 12 or less. In this case, the compatibility with the paste is increased, and the removal of the paste becomes easy.

The number of substituents that the component (A) has is one or more and two or less, and examples of the substituents includes alkyl group having 1 or more and 6 or less carbon atoms, alkyl group having 1 or more and 6 or less carbon atoms and hydroxyl group, ester group having 1 or more and 4 or less carbon atoms, and ether group having 1 or more and 6 or less carbon atoms. When the number of substituents is 2, the substituents may be the same or may be of different types. Of these, a substituent with an ester group having 1 to 4 carbon atoms or an ether group having 1 to 6 carbon atoms is preferred, and a substituent with the ester group or the ether group but not with a hydroxyl group is preferred.

Specific examples of the component (A) include toluene, ethylbenzene, propylbenzene, butylbenzene, pentylbenzene, xylene, methyl benzoate, ethyl benzoate, propyl benzoate, phenoxyethanol, ethyl phenyl ether, butyl phenyl ether, 2-phenylethanol, 3-phenyl-1-propanol, terpineol, dihydroterpineol, limonene, and methylcyclohexane.

In particular, ethyl benzoate, phenoxyethanol, ethyl phenyl ether, terpineol, and methylcyclohexane are preferred, and ethyl benzoate and ethyl phenyl ether are more preferred.

The content of the component (A) based on the total mass of the cleaning agent is 0.5% by mass or more and 10% by mass or less, preferably 1% by mass or more and 8% by mass or less, and more preferably 2% by mass or more and 6% by mass or less. When the content of the component (A) is 0.5% by mass or more, the component (A) is more likely to contact the paste, making it easier to remove the paste. When the content of the component (A) is 10% by mass or less, the component (A) is easily dissolved, and the storage stability is improved.

### [Component (B)]

A component (B) is a compound represented by Formula (1). The cleaning agent may contain only one type of component (B) or may contain a plurality of types of component (B).

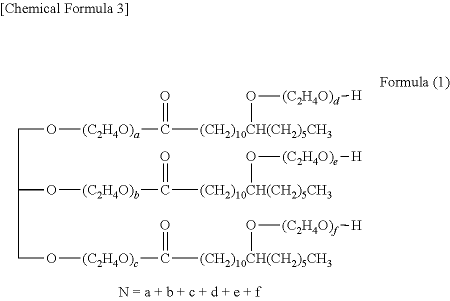

In Formula (1), N representing the sum of average addition mole numbers of C₂H₄O group (average numbers of moles of C₂H₄O group added) is the number of 20 or more and 100 or less. Note that any one or more of a to f may be 0. As the triglyceride represented by Formula (1) has C₂H₄O group in an amount such that N representing the sum of average addition mole numbers of C₂H₄O group is 20 or more and 100 or less, the solubility of the component (A) is increased and the storage stability is improved. Further, as N is the number of 20 or more and 100 or less, the permeation into the emulsion section of a screen plate can be suppressed, and the plate change rate is reduced. N is preferably 30 or more and 90 or less, and more preferably 50 or more and 70 or less.

The component (B) preferably has a hydrophilic-lipophilic balance (HLB) value of 12 or more and 17 or less, more preferably 13 or more and 16 or less. When the HLB value of the component (B) is 12 or more and 17 or less, the solubility of the component (A) is increased, and the storage stability is improved.

The content of the component (B) based on the total mass of the cleaning agent is 1% by mass or more and 10% by mass or less, preferably 3% by mass or more and 8% by mass or less, and more preferably 4% by mass or more and 6% by mass or less. When the content of the component (B) is 1% by mass or more, the affinity of the component (A) with water is increased, thereby improving the storage stability. When the content of the component (B) is 10% by mass or less, the permeation into the emulsion section of a screen plate can be suppressed, and the plate change rate is reduced.

### [Component (C)]

A component (C) is a compound (polyalkylene glycol) represented by Formula (2). The cleaning agent may contain only one type of component (C) or may contain a plurality of types of component (C).

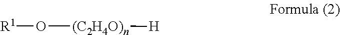

In Formula (2), R¹ represents a branched alkyl group having 6 or more and 18 or less carbon atoms. In particular, R¹ is preferably a branched alkyl group having 8 or more and 10 or less carbon atoms. When R¹ is a branched alkyl group having 6 or more and 18 or less carbon atoms, the solubility of the component (A) is increased, and the storage stability is improved.

The branched chain in R¹ is preferably an alkyl group having 1 or more and 3 or less carbon atoms, and is preferably a methyl branch or an ethyl branch.

Specific examples of R¹ include isooctyl group, 2-ethylhexyl group, isononyl group, 3,5,5-trimethylhexyl group, and isodecyl group.

In Formula (2), n is average addition mole number of oxyethylene group (C₂H₄O) and is the number of 2 or more and 12 or less. Herein, n is preferably the number of 4 or more and 10 or less.

The hydrophilic-lipophilic balance (HLB) value of the component (C) is not particularly limited, but may be, for example, 10 or more and 14 or less, preferably 11 or more and 13 or less, and more preferably 13. When the value is within the above range, the solubility of the component (A) is increased, the storage stability is improved, the permeation into the emulsion section of a screen plate can be suppressed, and the plate change rate is reduced.

The content of the component (C) based on the total mass of the cleaning agent is 1% by mass or more and 10% by mass or less, preferably 3% by mass or more and 8% by mass or less, and more preferably 4% by mass or more and 6% by mass or less. When the content of the component (C) is 1% by mass or more, the solubility of the component (A) is increased, and the storage stability is improved. When the content of the component (C) is 10% by mass or less, the permeation into the emulsion section of a screen plate can be suppressed, and the plate change rate is reduced.

### [Component (D)]

A component (D) is a surfactant having an aromatic group, and is a compound having an ionic hydrophilic group and a long-chain alkyl group, namely a hydrophobic group, in one molecule. In the case of a cationic surfactant, the ionic hydrophilic group may be, for example, a quaternary ammonium ion, and in the case of an anionic surfactant, the ionic hydrophilic group may be, for example, a sulfonic acid ion. The counter ion is not particularly limited. The chain length of the long-chain alkyl group, namely the hydrophobic group, is not particularly specified, but the number of carbon atoms of the long-chain alkyl group is preferably 8 to 18 or less, which is typical in commercially available surfactants.

By using a surfactant having an aromatic group as the component (D), it is possible to increase the solubility of the component (A), improve the storage stability, and suppress the permeability of the cleaning agent into the plate, thereby reducing the plate change rate.

Specific examples of the cationic surfactant include benzyl cetyl dimethyl ammonium chloride, benzyl dimethyl stearyl ammonium chloride, coconut alkyl dimethyl benzyl ammonium chloride, benzyl cetyl dimethyl ammonium bromide, benzyl dimethyl stearyl ammonium bromide, and coconut alkyl ammonium bromide. Specific examples of the anionic surfactant include sodium linear alkylbenzene sulfonate (LAS) and sodium branched alkylbenzene sulfonate (ABS).

In particular, coconut alkyl ammonium chloride and sodium linear alkylbenzene sulfonate (LAS) are preferred. The cleaning agent may contain only one type of component (D) or may contain a plurality of types of component (D) as long as the ionicity of the hydrophilic groups is the same.

The content of the component (D) based on the total mass of the cleaning agent is 0.1% by mass or more and 5% by mass or less, preferably 0.5% by mass or more and 4% by mass or less. When the content of the component (D) is 0.1% by mass or more, the solubility of the component (A) is increased, and the storage stability is improved. When the content of the component (D) is 5% by mass or less, the permeation into the plate is suppressed, and the plate change rate is reduced.

### [Water]

As the water, ion-exchanged water, distilled water, RO water, tap water, industrial water, or the like may be used.

The content of the water based on the total mass of the cleaning agent is 65.0% by mass or more and 97.4% by mass or less, and preferably 72% by mass or more and 92.5% by mass or less, and more preferably 78.0% by mass or more and 89.5% by mass or less.

The cleaning agent preferably has a liquid property of a pH ranging from weakly acidic to neutral. The liquid property of a pH ranging from weakly acidic to neutral means that the pH is 5.0 to 8.0. An example of the method for adjusting the pH to weakly acidic or neutral is a method using a pH adjuster.

### [Additional Components]

The cleaning agent may further include one or more additional components that are generally blended in conventional cleaning agents for paste, in addition to the components described above. Examples of the additional components include preservatives, thickeners, and colorants.

The composition of the present invention can be used as a stock solution, that is, it can be used as is, or it can be diluted with water as needed. The dilution ratio is appropriately determined according to the use, purpose, and the like, and is, for example, 2 to 50 times.

### [Use of Cleaning Agent]

The cleaning agent is used to remove a paste that is temporarily adhered to the surface of a screen plate.

It is considered that the cleaning agent permeates a paste at the interface between the screen and the paste, thereby removing the paste. In order to achieve these effects more fully, it is preferable to allow the cleaning agent to sufficiently permeate the paste so that a sufficient amount of the cleaning agent reaches the interface between the screen plate and the paste.

The temperature of the cleaning agent when it is brought into contact with the paste is preferably about 25 to 70° C.

A paste is a general term for a material in which solid particles are dispersed in a synthetic resin. Examples of the synthetic resin includes thermoplastic resins such as acrylic resin and polyester resin, and thermosetting resins such as phenol resin and epoxy resin. Examples of the solid particles include carbon black or metal particles (such as silver, copper, and nickel) with a size ranging from submicron to hundreds of microns, tin oxide, ceramics, and the like. In particular, when the cleaning agent is used for cleaning a paste containing a filler, the cleaning agent of the present invention exhibits remarkable effects in terms of high cleaning power, suppression of influence on emulsions, and uniformity in appearance.

### Examples

Hereinafter, the present invention will be described with reference to Examples and Comparative Examples; however, the present invention is not limited to the following Examples.

### 1. Preparation of Cleaning Agent

### 1-1. Material

### 1-1-1. Component (A)

Compounds A1 to A5 and Compound A1′ shown in Table 1 were prepared. Compounds A1 to A5 are compounds (component (A)) each having an alicyclic hydrocarbon group or an aromatic hydrocarbon group, and each having a molecular weight of 90 or more and 180 or less. In addition, compound A1′ is a compound that is not the component (A) due to having a different chemical structure.

Table 1 shows the compound name, the molecular weight, the total number of carbon atoms, and the number of substituents for Compound A1 to Compound A5 and Compound A1′.

TABLE 1

| | | | Total number | Number of |
|---|---|---|---|---|
| | Name of | Molecular | of carbon | substit- |
| Compound | compound | weight | atoms | uents |
| A1 | Ethyl benzoate | 150.17 | 9 | 1 |
| A2 | Phenoxyethanol | 138.16 | 8 | 1 |
| A3 | Ethyl phenyl | 122.16 | 8 | 1 |
| | ether | | | |
| A4 | Terpineol | 154.25 | 10 | 2 |
| A5 | Methylcyclo- | 98.19 | 7 | 1 |
| | hexane | | | |
| A1′ | 1-Hexanol | 102.17 | 6 | 1 |

### 1-1-2. Component (B)

Compounds B1 to B2 and compound B1′ shown in Table 2 were prepared. Compounds B1 to B2 are compounds (component (B)) represented by Formula (1), and compound B1′ is a compound that is not the component (B) due to having a different chemical structure.

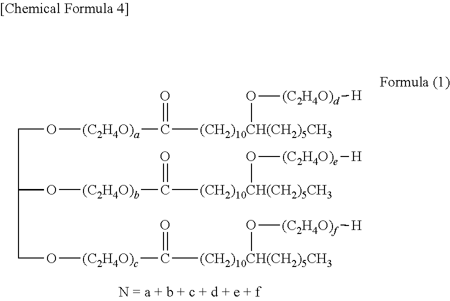

Table 2 shows the compound name and the HLB value for Compound B1 to Compound B2 and Compound B1′.

TABLE 2

| Compound | Name of compound | HLB value |
|---|---|---|
| B1 | PEG-60 hydrogenated castor oil | 15 |
| B2 | PEG-40 hydrogenated castor oil | 13 |
| B1′ | Polysorbate 80 | 16 |

### 1-1-3. Component (C)

Compounds C1 to C2 and Compound C1′ shown in Table 3 were prepared. Compounds C1 to C2 are compounds (component (C)) represented by Formula (2), and compound C1′ has a structure represented by Formula (2), but is a compound that is not the component (C) due to having a different chemical structure.

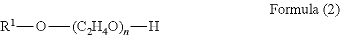

Table 3 shows the functional group name, the number of carbon atoms, and the linear or branched structure of R¹ in Formula (2), the number n of oxyethylene group (C₂H₄O), and the HLB value for compound C1 to compound C2 and compound C1′.

TABLE 3

| | R¹ | | | | |
|---|---|---|---|---|---|
| | Name of functional | Number of | | | HLB |
| Compound | group | carbon atoms | Structure | n | value |
| C1 | Isodecyl group | 10 | Branched | 6 | 13 |
| C2 | 2-Ethylhexyl group | 8 | Branched | 4 | 12 |
| C1′ | Cetyl group | 16 | Linear | 8 | 12 |

### 1-1-4. Component (D)

Compounds D1 to D2 and Compound D1′ shown in Table 4 were prepared. Compounds D1 to D2 are surfactants (component (D)) each having an aromatic group, and compound D1′ is a compound that is not the component (D) due to having a different chemical structure.

Table 4 shows the compound name, the number of carbon atoms in alkyl group, the presence or absence of an aromatic group, and the type of surfactant for Compounds D1 to D2 and Compound D1′.

TABLE 4

| | | Number of | Presence or | |
|---|---|---|---|---|
| | | carbon atoms | absence of | |
| | Name of | in alkyl | aromatic | |
| Compound | compound | group | group | Type |
| D1 | Coconut alkyl | 8 to 18 | Present | Cationic |
| | dimethyl benzyl | | | surfactant |
| | ammonium | | | |
| | chloride | | | |
| D2 | Sodium linear | 10 to 14 | Present | Anionic |
| | alkylbenzene | | | surfactant |
| | sulfonate | | | |
| D1′ | Coconut alkyl | 8 to 18 | Absent | Cationic |
| | trimethyl | | | surfactant |
| | ammonium | | | |
| | chloride | | | |

### 1-2. Preparation of Cleaning Agent

The above components and water were blended such that the total amount was 100% by mass to prepare the cleaning agent compositions of Examples 1 to 8 and Comparative Examples 1 to 8.

### 2. Appearance Evaluation

The appearance of each cleaning agent composition of Examples 1 to 8 and Comparative Examples 1 to 8 was confirmed after storage at 25° C. for four weeks.

Each cleaning liquid was evaluated based on the following criteria for the above test.

### <(1) Appearance Evaluation>

∘: Transparent
x: Cloudy or separated into two layers

### 3. Evaluation of Cleaning Agent

The cleaning agent compositions of Examples 1 to 8 and Comparative Examples 1 to 8 prepared above were evaluated according to the following criteria.

### 3-1. Cleaning Test

### 3-1-1. Preparation of Cleaning Test Piece (Cleaning Evaluation)

The weight of a 30 mm×10 mm metal mesh (100 mesh) was recorded in advance. Subsequently, a paste (“DY-150H-30” with binder of thermosetting resin and filler of carbon black, manufactured by Toyobo Co., Ltd.) was applied to the lower half of the mesh, 10 mm in area, and the excess paste was removed to prepare a test piece. The weight of the test piece to which the paste was applied was reweighed, and the amount of the applied paste was recorded.

### 3-1-2. Cleaning Test

To a 20 mL screw tube, 10 g of the prepared cleaning agent was added and kept at 60° C. The test piece prepared as described above was fully immersed in a cleaning agent maintained at 60° C., and irradiated with ultrasonic waves for 10 minutes using an ultrasonic cleaner (“BRANSON B-220”, manufactured by Emerson Electric Co.) while maintaining the temperature at 60° C. Subsequently, the test piece was rinsed with ion-exchanged water, satisfactorily dried, and the weight of the test piece was measured. The cleaning rate was calculated from the weight change of the test piece before and after cleaning. The method for calculating the cleaning rate is as follows. The present test was performed twice, and the average value was used as the measurement result of the present test.

$$[ Expression 1 ]$$

$$CLEANING RATE ( \% ) = \frac{\begin{matrix}WEIGHT OF APPLIED PASTE ( g ) - \\ WEIGHT OF PASTE AFTER CLEANING ( g )\end{matrix}}{WEIGHT OF APPLIED PASTE ( g )} \times 100$$

Based on the measured cleaning rate, each cleaning liquid was evaluated according to the following criteria.

### <(2) Cleaning Evaluation>

⊚: The cleaning rate is 95% or more.
∘: The cleaning rate is 80% or more and less than 95%.
x: The cleaning rate is less than 80%.

### 3-2. Influence on Plate

### 3-1-1. Preparation of Test Piece

A screen plate (ST325, manufactured by Tokyo Process Service Co., Ltd.) cut into 30 mm×10 mm was used as a test piece, and the weight of the test piece was measured and recorded.

### 3-1-2. Plate Change Rate

To a 20 mL screw tube, 10 g of the prepared cleaning agent was added and kept at 60° C. The test piece prepared as described above was fully immersed in a cleaning agent maintained at 60° C., and irradiated with ultrasonic waves for 10 minutes using an ultrasonic cleaner (“BRANSON B-220”, manufactured by Emerson Electric Co.) while maintaining the temperature at 60° C. Subsequently, the test piece was rinsed with ion-exchanged water, satisfactorily dried, and the weight of the test piece was measured. The change rate was calculated from the weight change of the test piece before and after the test. The method for calculating the change rate is as follows. The present test was performed twice, and the average value was used as the measurement result of the present test.

$$[ Expression 2 ]$$

$$PLATE CHANGE RATE ( \% ) = \frac{\begin{matrix}WEIGHT OF TEST PIECE AFTER TEST ( g ) - \\ WEIGHT OF TEST PIECE BEFORE TEST ( g )\end{matrix}}{WEIGHT OF TEST PIECE BEFORE TEST ( g )} \times 100$$

Based on the measured change rate, each cleaning liquid was evaluated according to the following criteria.

### <(3) Plate Change Rate>

⊚: The change rate is within ±0.5%.
∘: The change rate is more than ±0.5% and equal to or less than ±1.0%.
x: The change rate exceeds ±1.0%.

The content of each component included in the cleaning agent composition of Examples 1 to 8 and Comparative Examples 1 to 8, and the results of the evaluation of each cleaning liquid are shown in Tables 5 to 6. The numerical values for the components in Tables 5 to 6 each represent the percentage (in mass %) based on the total mass of the cleaning agent.

TABLE 5

| Remarks | | | Example 1 | Example 2 | Example 3 | Example 4 | Example 5 | Example 6 | Example 7 | Example 8 |
|---|---|---|---|---|---|---|---|---|---|---|
| Cleaning | Component (A) | A1 | 5 | | | | | 5 | 2 | 3 |
| liquid | Organic solvent | A2 | | 6 | | | | | | |
| | | A3 | | | 4 | 1 | | | | |
| | | A4 | | | | 3 | | | | |
| | | A5 | | | | | 4 | | | |
| | Component (B) | B1 | 5 | 4 | 6 | 5 | 5 | | 5 | 5 |
| | Solubilizer | B2 | | 2 | | | | 5 | | |
| | Component (C) | C1 | 4 | 4 | 4 | 4 | 4 | 4 | | 5 |
| | Solubilization aid | C2 | | | | 1 | | | 5 | |
| | Component (D) | D1 | 0.5 | 1 | 0.5 | 0.5 | 0.5 | 0.5 | 1 | |
| | Solubilization aid | D2 | | | | | | | | 0.5 |
| | Water | | Balance | Balance | Balance | Balance | Balance | Balance | Balance | Balance |
| Evaluation | (1) Appearance | Evaluation | ◯ | ◯ | ◯ | ◯ | ◯ | ◯ | ◯ | ◯ |
| results | (2) Cleaning rate | Evaluation | ⊚ | ◯ | ⊚ | ⊚ | ◯ | ⊚ | ⊚ | ⊚ |
| | | (%) | 99 | 82 | 96 | 97 | 84 | 96 | 95 | 97 |
| | (3) Plate change | Evaluation | ⊚ | ◯ | ⊚ | ◯ | ◯ | ⊚ | ◯ | ◯ |
| | rate | (%) | 0.2 | 0.9 | 0.4 | 0.8 | 0.6 | 0.2 | 1.0 | 1.0 |

TABLE 6

| | | | Compar- | Compar- | Compar- | Compar- | Compar- | Compar- | Compar- | Compar- |
|---|---|---|---|---|---|---|---|---|---|---|
| | | | ative | ative | ative | ative | ative | ative | ative | ative |
| | | | Exam- | Exam- | Exam- | Exam- | Exam- | Exam- | Exam- | Exam- |
| Remarks | | | ple 1 | ple 2 | ple 3 | ple 4 | ple 5 | ple 6 | ple 7 | ple 8 |
| Cleaning | Component (A) | A1 | | | 5 | 5 | 5 | 5 | 5 | 5 |
| liquid | Organic solvent | A1′ | | 5 | | | | | | |
| | Component (B) | B1 | 5 | 5 | | | 8 | 6 | 6 | 5 |
| | Solubilizer | B1′ | | | | 5 | | | | |
| | Component (C) | C1 | 4 | 4 | 10 | 4 | | | 5 | 4 |
| | Solubilization aid | C1′ | | | | | | 5 | | |
| | Component (D) | D1 | 0.5 | 0.5 | 0.5 | 0.5 | 1 | 1 | | |
| | Solubilization aid | D1′ | | | | | | | | 1 |
| | Water | | Balance | Balance | Balance | Balance | Balance | Balance | Balance | Balance |
| Evaluation | (1) Appearance | Evaluation | ◯ | X | X | X | X | X | X | X |
| results | (2) Cleaning rate | Evaluation | X | ◯ | ⊚ | ◯ | ◯ | ◯ | ◯ | (⊚) |
| | | (%) | 18 | 94 | 95 | 92 | 92 | 94 | 94 | 98 |
| | (3) Plate change | Evaluation | ⊚ | ⊚ | X | ◯ | ◯ | X | ◯ | X |
| | rate | (%) | 0.2 | 0.5 | 1.4 | 0.6 | 1.0 | 1.5 | 1.0 | 1.1 |

As shown in Tables 5 to 6, cleaning agents including the component (A), the component (B), the component (C), the component (D), and water have a sufficient cleaning power to remove the paste, suppress the influence on the emulsion of the screen plate, and achieve a uniform appearance, and includes water as the main component.

The present application claims priority to Japanese Patent Application No. 2022-163189, filed on Oct. 11, 2022, the entire contents of which are incorporated herein by reference.

### INDUSTRIAL APPLICABILITY

The present invention is applicable to the cleaning agent composition for paste adhering to a device or a screen plate, which has a sufficient cleaning power to remove the paste, thereby contributing to an improvement in productivity. In addition, the influence on an emulsion of a screen plate can be reduced, allowing the screen plate to be reused, which leads to a reduction in waste.

1. A cleaning agent composition comprising:
0.5% by mass or more and 10% by mass or less of a component (A);
1% by mass or more and 10% by mass or less of a component (B);
1% by mass or more and 10% by mass or less of a component (C);
0.1% by mass or more and 5% by mass or less of a component (D); and
65.0% by mass or more and 97.4% by mass or less of water,
wherein
the component (A) is a compound having an alicyclic hydrocarbon group or an aromatic hydrocarbon group and having a molecular weight of 90 or more and 180 or less,
the component (B) is a compound represented by Formula (1): 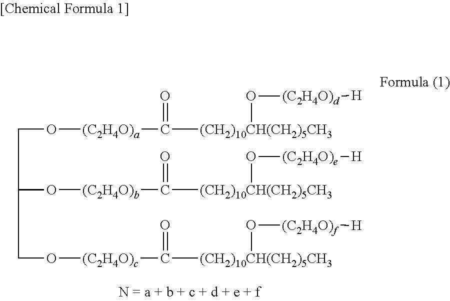
in Formula (1), N representing a sum of average addition mole numbers of C₂H₄O group is a number of 20 or more and 100 or less,
the component (C) is a compound represented by Formula (2): 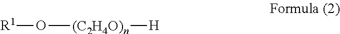
in Formula (2), R¹ represents a branched alkyl group having 6 or more and 18 or less carbon atoms, and n representing an average addition mole number of C₂H₄O group is a number of 2 or more and 12 or less, and
the component (D) is a surfactant having an aromatic group.

2. A method for cleaning a paste, the method comprising:
preparing a screen plate with a surface to which the paste adheres; and
bringing the cleaning agent composition according to claim 1 into contact with the surface of the screen plate, the surface being a surface to which the paste adheres.
